(19) United States
(12) Patent Application Publication
(10) Pub. No.: US 2026/0254240 A1
(43) Pub. Date: Aug. 27, 2026

(54) FAULT RIDE-THROUGH METHOD, SYSTEM, ELECTRONIC DEVICE, AND STORAGE MEDIUM FOR RENEWABLE ENERGY INTEGRATION CONVERTER STATIONS

(71) Applicant: Shandong University, Jinan (CN)

(72) Inventors: Quanrui HAO, Jinan (CN); Lei YAN, Jinan (CN); Lei DING, Jinan (CN)

(73) Assignee: Shandong University, Jinan (CN)

(21) Appl. No.: 19/289,359

(22) Filed: Aug. 4, 2025

(30) Foreign Application Priority Data
Feb. 27, 2025 (CN) 2025102205057

(51) Int. Cl. H02J 3/00; H02J 3/36; H02J 3/38; H02J 13/00

(52) U.S. Cl. CPC H02J 3/0012; H02J 3/36; H02J 3/381; H02J 13/12; H02J 13/333; H02J 2101/28; H02J 2103/30

(57) ABSTRACT

Disclosed are a fault ride-through method, system, electronic device, and storage medium for a renewable energy integration converter station in the technical field of VSC-HVDC power transmission in power systems, where the method includes: performing fault detection on a renewable energy station and a sending-end converter station, and acquiring fault information upon detecting a fault; calculating, based on the fault information, control commands for the renewable energy station and the sending-end converter station; and transmitting the control commands to the renewable energy station and the sending-end converter station to achieve fault ride-through control. Fault equivalent models for the renewable energy station and the sending-end converter stations are proposed, and these models fully leverage the flexible control and coordination capabilities of the two types of converters, helping improve the grid-connected performance of renewable energy VSC-HVDC islanded systems during a fault.

### CROSS-REFERENCE TO RELATED APPLICATIONS

The application claims priority to Chinese patent application No. 2025102205057, filed on Feb. 27, 2025, the entire contents of which are incorporated herein by reference.

### TECHNICAL FIELD

This disclosure relates to the technical field of Voltage Source Converter-Based High-Voltage Direct Current (VSC-HVDC) power transmission in power systems, and in particular, to a fault ride-through method, system, electronic device, and storage medium for a renewable energy integration converter station.

### BACKGROUND

Wind power, photovoltaic (PV) power, and other clean and renewable energy sources play an important role in promoting global energy transformation. The VSC-HVDC power transmission technology is a key solution for long-distance renewable energy delivery. When a fault occurs in an AC collection line at a renewable energy sending end, it can easily cause active power to backfeed from an onshore grid to a sending-end system, resulting in a substantial active power deficit in the onshore grid during the fault. Therefore, during the fault in the sending-end collection line, maximizing the transmission of the active power of the renewable energy to a receiving end while ensuring the safety of renewable energy converters and a sending-end converter station is of great significance for the safe operation of the onshore grid.

An existing fault ride-through strategy proposed for wind farms in the prior art involves replacing a conventional reactive power priority control strategy with an active power priority control strategy for a wind turbine generator system during a fault, which enables easier stabilization of the AC voltage of the system. However, this strategy has drawbacks: the sending-end converter station is still simplistically modeled as a constant current source during a fault, failing to effectively utilize its flexible control capability or achieve effective coordination with renewable energy stations. Another method proposed involves step-down current limiting at a sending-end VSC-HVDC converter station, where the voltage is reduced in segments based on the actual output current during a fault. However, this method also has its drawbacks: it only addresses over-current issues in severe fault conditions and does not resolve the widespread problem of large active power backfeeding to an onshore grid during sending-end faults. Additionally, an optimized design method for current parameters of PV inverters and a sending-end converter station during a fault has been proposed, analyzing the impact of current setpoints of converters on both sides of a fault point on the DC voltage of a VSC-HVDC side through simulations. Nevertheless, this method still has its drawbacks: it lacks comprehensive theoretical analysis and does not account for constraints such as the active power output of renewable energy sources.

In conclusion, existing fault ride-through methods for collection systems of renewable energy integration converter stations fail to effectively utilize the coordinated control capability of renewable energy converters and sending-end converter stations, cannot fundamentally address the active power backfeeding issue in the onshore grid, and incomprehensively consider the operational constraints of renewable energy stations and VSC-HVDC converter stations.

### SUMMARY

Embodiments of this disclosure are intended to provide a fault ride-through method, system, electronic device, and storage medium for renewable energy integration converter stations, aiming to fully or at least partially solve the above technical problems of failure to effectively utilize the coordinated control capability of renewable energy converters and sending-end converter stations, incapability of fundamentally addressing the active power backfeeding issue in the onshore grid, and lack of comprehensive consideration for the operational constraints of renewable energy stations and VSC-HVDC converter stations.

In a first aspect, an embodiment of this disclosure provides a fault ride-through method for a renewable energy integration converter station, including:
performing fault detection on a renewable energy station and a sending-end converter station, and acquiring fault information upon detecting a fault;
calculating, based on the fault information, control commands for the renewable energy station and the sending-end converter station; and
transmitting the control commands to the renewable energy station and the sending-end converter station to achieve fault ride-through control.

Optionally, before the step of performing the fault detection on the renewable energy station and the sending-end converter station, and acquiring the fault information upon detecting the fault, the fault ride-through method for the renewable energy integration converter station further includes: establishing fault equivalent models for the renewable energy station and the sending-end converter station:

equivalently modeling the renewable energy station and the sending-end converter station as a controlled current source and a controlled voltage source, respectively, where a root-mean-square (RMS) value and phase angle of an output current of the controlled current source are controlled variables; and an RMS value of an output voltage of the controlled voltage source is a controlled variable.

Optionally, the step of calculating, based on the fault information, the control commands for the renewable energy station and the sending-end converter station includes:

calculating, based on the fault information, an RMS current value of the sending-end converter station, the output voltage of the sending-end converter station, and an active power output of the renewable energy station under theoretical optimal control of common controlled variables for the renewable energy station and the sending-end converter station; and

determining whether the RMS current value of the sending-end converter station, the output voltage of the sending-end converter station, and the active power output of the renewable energy station exceed their limits: if yes, by taking theoretical optimal values of the common controlled variables for the renewable energy station and the sending-end converter station as initial guess points, solving for reference values of the controlled variables through nonlinear programming, and using the solved reference values of the controlled variables as the control commands; or, if no, using theoretical optimal values of the common controlled variables for the renewable energy station and the sending-end converter station as reference values of the controlled variables, and using the reference values of the controlled variables as the control commands.

Optionally, the theoretical optimal values of the common controlled variables for the renewable energy station and the sending-end converter station are represented as follows:

$$\{ \begin{matrix}{I}_{w 1}^{*} = \frac{{I}_{w 1 max}}{\sqrt{2}} \\ {I}_{w i}^{*} = \frac{{I}_{wi max}}{\sqrt{2}} \\ {θ}_{w 1}^{*} = \frac{π}{2} - arctan ( \frac{R}{X} ) \\ {θ}_{w i}^{*} = \frac{π}{2} - arctan ( \frac{{R}^{2} + {XX}_{0}}{R {X}_{t}} ) ( i = 2 , 3 , 4 … N ) \\ {U}_{M}^{*} = \frac{{R}_{f} \sqrt{{R}^{2} + {X}^{2}} {I}_{w 1 max}}{2 \sqrt{2} R} + \\ \frac{\sqrt{{( {R}^{2} + {XX}_{0} )}^{2} + {( R {X}_{t} )}^{2}} {\sum }_{i = 2}^{N} {I}_{wi max}}{2 \sqrt{2} R}\end{matrix}$$

where w1 represents a renewable energy station on a faulted branch; wi represents a renewable energy station on a non-faulted branch; I_{wimax} represents a maximum output current of an i^{th} station; R_{f} represents a fault resistance; Xₜ represents leakage inductance of a connected transformer; X₀ represents an equivalent reactance from a fault point to a point of common coupling (PCC); R=R_{f}+R₀, representing a total fault resistance; X=Xₜ+X₀; * represents a theoretical optimal value without considering other constraints; U_{M} represents the output voltage of the sending-end converter station; and θ_{wi} represents the phase angle of the output current of the renewable energy station.

Optionally, based on the fault information, the RMS current value of the sending-end converter station under the theoretical optimal control of the common controlled variables for the renewable energy station and the sending-end converter station is calculated according to the following formulas:

$${I}_{M}^{*} = \frac{{C}_{1} {I}_{w 1 max} + {C}_{2} {Σ}_{i = 2}^{N} {I}_{wi max}}{\sqrt{2}} ;$$

$${C}_{1} = \frac{{R}_{f}}{2 R} ;$$

$${C}_{2} = \sqrt{\frac{1}{4} + \frac{{X}_{0}^{2}}{4 {R}^{2}} ;}$$

where R_{f} represents the fault resistance; I_{wimax} represents the maximum output current of the i^{th} station; and X₀ represents the equivalent reactance from the fault point to the PCC.

Optionally, based on the fault information, the output voltage of the sending-end converter station under the theoretical optimal control of the common controlled variables for the renewable energy station and the sending-end converter station is calculated according to the following formula:

$${U}_{M}^{*} = \frac{{R}_{f} \sqrt{{R}^{2} + {X}^{2}} {I}_{w 1 max} + \sqrt{{( {R}^{2} + {XX}_{0} )}^{2} + {( R {X}_{t} )}^{2}} {\sum }_{i = 2}^{N} {I}_{wi max}}{2 \sqrt{2} R} ;$$

where R_{f} represents the fault resistance; I_{wimax} represents the maximum output current of the i^{th} station; X₀ represents the equivalent reactance from the fault point to the PCC; and Xₜ represents the leakage inductance of the connected transformer.

Optionally, based on the fault information, the active power output of the renewable energy station under the theoretical optimal control of the common controlled variables for the renewable energy station and the sending-end converter station is calculated according to the following formulas:

$${P}_{w 1}^{*} = Re \{ [ ( {i}_{w 1}^{*} - {i}_{0}^{*} ) {R}_{f} + {i}_{w 1}^{*} ( {R}_{1} + {jX}_{1} ) ] \overline{{i}_{w 1}^{*}} \} ;$$

$${P}_{w i}^{*} = Re \{ [ ( {i}_{w 1}^{*} - {i}_{{0}^{*}} ) {R}_{f} - {i}_{0}^{*} ( {R}_{0} + {jX}_{0} ) + {i}_{w i}^{*} ( {R}_{i} + {jX}_{i} ) ] \overline{{i}_{w 1}^{*}} \}$$

where

$${P}_{w 1}^{*} and {P}_{w i}^{*}$$

represent active power outputs of the renewable energy station on the faulted branch and the renewable energy station on the non-faulted branch, respectively; Rᵢ and Xᵢ represent an equivalent resistance and reactance from an outlet of a renewable energy station on an i^{th} non-faulted branch to the PCC; R_{f} represents the fault resistance; and R₀ and X₀ represent an equivalent resistance and the equivalent reactance from the fault point to the PCC.

In a second aspect, an embodiment of this disclosure provides a fault ride-through system for a renewable energy integration converter station, including:
an acquisition unit, configured to perform fault detection on a renewable energy station and a sending-end converter station, and acquire fault information upon detecting a fault;
a calculation unit, configured to calculate, based on the fault information, control commands for the renewable energy station and the sending-end converter station; and
a control unit, configured to transmit the control commands to the renewable energy station and the sending-end converter station to achieve fault ride-through control.

In a third aspect, an embodiment of this disclosure further provides an electronic device, including a memory, a processor, and a computer program stored on the memory and executable on the processor, where the processor, when executing the computer program, implements the steps of the fault ride-through method for the renewable energy integration converter station as described above.

In a fourth aspect, an embodiment of this disclosure provides a storage medium having a computer program stored thereon, where the computer program, when executed by a processor, implements the steps of the fault ride-through method for the renewable energy integration converter station as described above.

As can be seen from the above technical solutions, this disclosure has the following advantages:
in the fault ride-through method, system, electronic device, and storage medium for the renewable energy integration converter station provided in this disclosure, fault equivalent models for the renewable energy station and the sending-end converter stations are proposed, and these models fully leverage the flexible control and coordination capabilities of the two types of converters, helping improve the grid-connected performance of renewable energy VSC-HVDC islanded systems during a fault. Moreover, when AC collection lines at the sending end experience a fault of any severity, the renewable energy station and the sending-end converter station, are controlled through the control commands, greatly reducing the active power deficit imposed on the onshore grid due to sending-end faults. This solution fully considers operational constraints of both the renewable energy station and the converter station, ensuring their safe operation during a fault.

### BRIEF DESCRIPTION OF THE DRAWINGS

To describe the technical solutions of this disclosure more clearly, the following briefly introduces the accompanying drawings required for description. Apparently, the accompanying drawings in the following description show merely some embodiments of this disclosure, and a person of ordinary skill in the art may still derive other accompanying drawings from these accompanying drawings without creative efforts.

FIG. 1 is a flow chart of a fault ride-through method for a renewable energy integration converter station according to an embodiment of this disclosure;

FIG. 2 is a typical topology diagram of a renewable energy grid-connected system using VSC-HVDC technology according to an embodiment of this disclosure;

FIG. 3 is a fault ride-through equivalent model of the system according to an embodiment of this disclosure;

FIG. 4 is a detailed flow chart of a fault ride-through method for a renewable energy integration converter station according to an embodiment of this disclosure;

FIG. 5 is a schematic structural diagram of a fault ride-through system for a renewable energy integration converter station according to an embodiment of this disclosure; and

FIG. 6 is a schematic hardware structure diagram of an electronic device according to an embodiment of this disclosure.

### DETAILED DESCRIPTION OF THE EMBODIMENTS

In the following detailed description, various embodiments of this disclosure will be described more comprehensively. This disclosure may have various embodiments, and modifications and variations may be made therein. However, it should be understood that there is no intention to limit the various embodiments of this disclosure to the specific embodiments disclosed herein. Rather, this disclosure should be construed as encompassing all modifications, equivalents, and/or alternatives that fall within the spirit and scope of the various embodiments of this disclosure.

Hereinafter, the term “including” or “may include” as used in the various embodiments of this disclosure indicates the existence of disclosed functions or operations, and does not preclude the addition of one or more other functions or operations. Furthermore, as used in the various embodiments of this disclosure, the terms “including”, “having”, and their cognates are intended solely to indicate the presence of specific features, numbers, steps, operations, or combinations thereof, and should not be construed as initially excluding the existence or possible addition of one or more other features, numbers, steps, operations, or combinations thereof.

In the various embodiments of this disclosure, the expression “or” or “at least one of A or/and B” encompasses any and all combinations of the listed items. For example, the expression “A or B” or “at least one of A or/and B” may include A, B, or both A and B.

The technical solutions in the embodiments of this disclosure will be clearly and completely described below with reference to the accompanying drawings in the embodiments of this disclosure. Apparently, the described embodiments represent only some rather than all of the embodiments of this disclosure. All other embodiments obtained by a person of ordinary skill in the art based on the embodiments of this disclosure without making creative efforts shall fall within the protection scope of this disclosure.

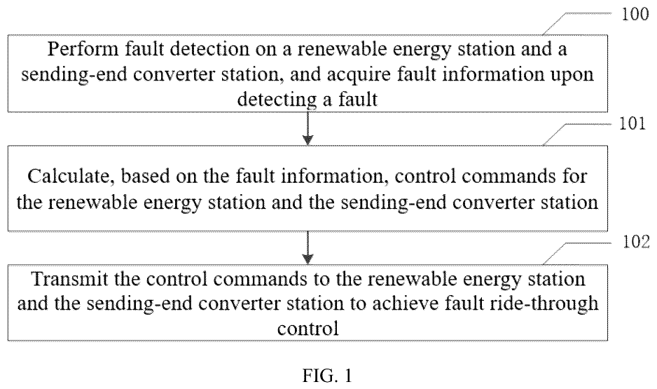

Referring to FIG. 1, it is a flow chart of a fault ride-through method for a renewable energy integration converter station according to an embodiment of this disclosure, where the method includes the following steps:

S100: performing fault detection on a renewable energy station and a sending-end converter station, and acquiring fault information upon detecting a fault.

In some implementation manners, before the step S100, the method further includes: equivalently modeling the renewable energy station and the sending-end converter station as a controlled current source and a controlled voltage source, respectively, where an RMS value and phase angle of an output current of the controlled current source are controlled variables; and an RMS value of an output voltage of the controlled voltage source is a controlled variable.

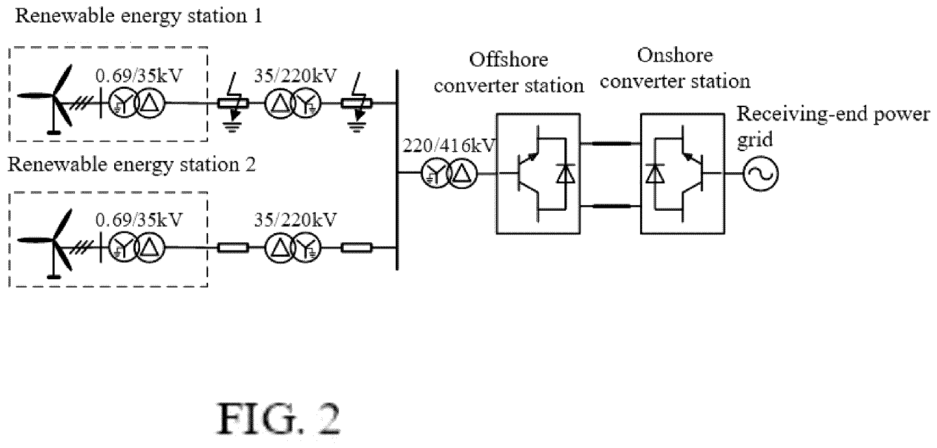

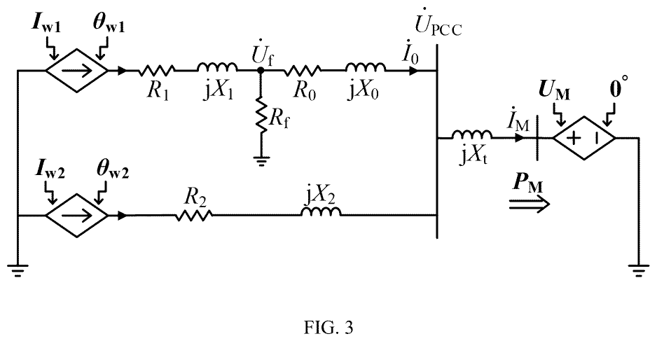

In some implementation manners, a typical topology of a renewable energy grid-connected system using VSC-HVDC technology is as shown in FIG. 2, and establishing fault equivalent models for the renewable energy station and the sending-end converter station forms a foundation for implementing fault ride-through control. The renewable energy station and the sending-end converter station are equivalently modeled as a controlled current source and a controlled voltage source, respectively, where an RMS value and phase angle of an output current of the controlled current source are controlled variables; and an RMS value of an output voltage of the controlled voltage source is a controlled variable. A fault ride-through equivalent model of the system is as shown in FIG. 3, where the RMS value I_{wj} and phase angle θ_{wj}(j=1,2,3 . . . N) of the output current of the wind farm, as well as the RMS value U_{M} of the output voltage of the offshore converter station, are controlled variables. This model forms a foundation for implementing fault ride-through control.

Based on the fault equivalent model shown in FIG. 3, the control objective of this disclosure is: to maximize active power transmission from the renewable energy station to the onshore grid (i.e., maximize P_{M}), where the RMS value I_{wj} and phase angle θ_{wj}(j=1,2,3 . . . N) of the output current of the renewable energy station, as well as the output voltage U_{M} of the sending-end converter station, are controlled variables. Taking N=2 as an example, analytical expressions for the controlled variables are derived, and a general selection principle is given.

The expression for P_{M} is as follows:

$${P}_{M} = 3 Re ( {\dot{U}}_{M} {\overline{\dot{I}}}_{M} ) = 3 {U}_{M} Re ( {i}_{M} ) \qquad ( 1 )$$

where P_{M} represents an active power transmitted to the onshore grid via the sending-end converter station; U_{M} represents an RMS value of a controlled voltage of the sending-end converter station; I_{M} represents an RMS value of an output current of the sending-end converter station; represents a phasor form of an electrical quantity; —represents a conjugate symbol; and Re represents taking the real part of a complex number.

A current I₀ flowing through a faulted branch can be expressed as follows:

$${\dot{I}}_{0} = {\dot{I}}_{M} - {\dot{I}}_{w 2} \qquad ( 2 )$$

$${\dot{I}}_{0} = \frac{{\dot{U}}_{f} - {\dot{U}}_{PCC}}{{R}_{0} + j {X}_{0}} \qquad ( 3 )$$

where I_{w2} represents an RMS value of an output current of the station 2; U_{f} represents a voltage at a fault point; U_{PCC} represents a voltage at an AC bus (PCC point) of the converter station; and R₀ and X₀ represent an equivalent resistance and reactance from the fault point to the PCC point, respectively.

The voltage at the fault point and the voltage at the PCC point can be expressed as follows:

$${\dot{U}}_{f} = ( {\dot{I}}_{w 1} - {\dot{I}}_{0} ) {R}_{f} \qquad ( 4 )$$

$${\dot{U}}_{PCC} = {U}_{M} + j {\dot{I}}_{M} {X}_{t} \qquad ( 5 )$$

where I_{w1} represents an RMS value of an output current of the station 1; R_{f} represents a fault resistance; and Xₜ represents leakage inductance of a connected transformer.

By combining Expressions (2)-(5), it can be obtained that:

$${\dot{I}}_{M} = \frac{{R}_{f}}{R + j X} {\dot{I}}_{w 1} + \frac{R + j {X}_{0}}{R + j X} {\dot{I}}_{w 2} - \frac{1}{R + j X} {U}_{M} \qquad ( 6 )$$

where R=R_{f}+R₀, and X=Xₜ+X₀.

When the phasor in Expression (6) is expressed in a trigonometric form, it can be obtained that:

$$Re ( {\dot{I}}_{M} ) = a - b {U}_{M} \qquad ( 7 )$$

$$where$$

$$a = \frac{{R}_{f} \sqrt{{R}^{2} + {X}^{2}} sin ( {θ}_{w 1} + arctan ( \frac{R}{X} ) )}{{R}^{2} + {X}^{2}} {I}_{w 1} + \frac{\sqrt{{( {R}^{2} + {XX}_{0} )}^{2} + {( R {X}_{t} )}^{2}} sin ( {θ}_{w 2} + arctan ( \frac{{R}^{2} + {XX}_{0}}{R {X}_{t}} ) )}{{R}^{2} + {X}^{2}} {I}_{w 2} \qquad ( 8 )$$

$$b = \frac{R}{{R}^{2} + {X}^{2}} \qquad ( 9 )$$

where θ₁ and θ₂ represent controlled phase angles of the output currents of the stations 1 and 2, respectively.

By combining Expressions (1) and (7), it can be obtained that:

$${P}_{M} = 3 ( - b {U}_{M}^{2} + a {U}_{M} ) \qquad ( 10 )$$

$$When$$

$${U}_{M} = \frac{a}{2 b} \qquad ( 11 )$$

P_{M} reaches its maximum:

$${P}_{M max} = \frac{3 {a}^{2}}{4 b} \qquad ( 12 )$$

where b remains constant during a fault. For a, I_{w1} and I_{w2} should be maximized while satisfying:

$$sin ( {θ}_{w 1} + arctan ( \frac{R}{X} ) ) = sin ( {θ}_{w 1} + arctan ( \frac{{R}^{2} + X {X}_{0}}{R {X}_{t}} ) ) = 1 \qquad ( 13 )$$

Considering the output current limiting effects in renewable energy converters, the following can be adopted:

$$\{ \begin{matrix}{I}_{w 1}^{*} = \frac{{I}_{W 1 max}}{\sqrt{2}} \\ {I}_{w 2}^{*} = \frac{{I}_{W 2 max}}{\sqrt{2}} \\ {θ}_{w 1}^{*} = \frac{π}{2} - arctan ( \frac{R}{X} ) \\ {θ}_{w 2}^{*} = \frac{π}{2} - arctan ( \frac{{R}^{2} + X {X}_{0}}{R {X}_{t}} )\end{matrix} \qquad ( 14 )$$

Under these conditions:

$${U}_{M}^{*} = \frac{{R}_{f} \sqrt{{R}^{2} + {X}^{2}} {I}_{w 1 max} + \sqrt{{( {R}^{2} + {XX}_{0} )}^{2} + {( R {X}_{t} )}^{2}} {I}_{w 2 max}}{2 \sqrt{2} R} \qquad ( 15 )$$

$${P}_{M}^{*} = \frac{3 {( {R}_{f} \sqrt{{R}^{2} + {X}^{2}} {I}_{w 1 max} + \sqrt{{( {R}^{2} + {XX}_{0} )}^{2} + {( R {X}_{t} )}^{2}} {I}_{w 2 max} )}^{2}}{4 R ( {R}^{2} + {X}^{2} )} \qquad ( 16 )$$

where I_{w1max} and I_{w2max} represent maximum output currents of the renewable energy stations 1 and 2, respectively; and * represents a theoretical optimal value without considering other constraints.

S101: calculating, based on the fault information, control commands for the renewable energy station and the sending-end converter station.

Specifically, when the step S101 is performed, the following steps may be performed:

S1010: calculating, based on the fault information, an RMS current value of the sending-end converter station, an output voltage of the sending-end converter station, and an active power output of the renewable energy station under theoretical optimal control of common controlled variables for the renewable energy station and the sending-end converter station.

Specifically, when the number of renewable energy stations is N, the same methodology can be applied to derive expressions for the theoretical optimal values of the common controlled variables for the renewable energy station and the sending-end converter station:

$$\{ \begin{matrix}{I}_{w 1}^{*} = \frac{{I}_{w 1 max}}{\sqrt{2}} \\ {I}_{w i}^{*} = \frac{{I}_{w i max}}{\sqrt{2}} \\ {θ}_{w 1}^{*} = \frac{π}{2} - arctan ( \frac{R}{X} ) \\ {θ}_{w i}^{*} = \frac{π}{2} - arctan ( \frac{{R}^{2} + {XX}_{0}}{{RX}_{t}} ) ( i = 2 , 3 , 4 … N ) \\ {U}_{M}^{*} = \frac{{R}_{f} \sqrt{{R}^{2} + {X}^{2}} {I}_{w 1 max}}{2 \sqrt{2 R}} \\ \frac{\sqrt{{( {R}^{2} + {XX}_{0} )}^{2} + {( {RX}_{t} )}^{2}} {\sum }_{i = 2}^{N} {I}_{wi max}}{2 \sqrt{2 R}}\end{matrix} \qquad ( 17 )$$

where w1 represents a renewable energy station on a faulted branch; wi represents a renewable energy station on a non-faulted branch; I_{wimax} represents a maximum output current of an i^{th} station; R_{f} represents a fault resistance; Xₜ represents leakage inductance of a connected transformer; X₀ represents an equivalent reactance from a fault point to a point of common coupling (PCC); R=R_{f}+R₀, representing a total fault resistance; X=Xₜ+X₀; * represents a theoretical optimal value without considering other constraints; U_{M} represents the output voltage of the sending-end converter station; and θ_{wi} represents the phase angle of the output current of the renewable energy station.

The selection principles for the controlled variables are given above, considering only the maximum output current constraint of the renewable energy station. However, in actual operation, using Expression (17) as the control variables under certain operating conditions may cause other electrical quantities of the dual-side converters to exceed their limits. To ensure the safety of the apparatus, the following additional constraints should be considered:

By combining Expressions (6), (14), and (15), the RMS phase current value of the sending-end converter station can be obtained as follows:

$${I}_{M}^{*} = \frac{{C}_{1} {I}_{w 1 max} + {C}_{2} {I}_{w 2 max}}{\sqrt{2}} \qquad ( 18 )$$

$$where$$

$${C}_{1} = \frac{{R}_{f}}{2 R} \qquad ( 19 )$$

$${C}_{2} = \sqrt{\frac{1}{4} + \frac{{X}_{0}^{2}}{4 {R}^{2}}} \qquad ( 20 )$$

where R_{f} represents the fault resistance; I_{wimax} represents the maximum output current of the i^{th} station; and X₀ represents the equivalent reactance from the fault point to the PCC.

It can be seen that when R is relatively small, the sending-end converter station may face over-current risks, and its current constraint should therefore be considered.

According to Expression (15), the optimal output voltage of the converter station during high-impedance faults can be approximated as follows:

$${U}_{M}^{*} \approx \frac{\sqrt{{R}_{f}^{2} + {X}^{2}} {I}_{w 1 max} + \sqrt{{R}_{f}^{2} + 2 {XX}_{0} + {X}_{{t}^{2}}} {I}_{w 2 max}}{2 \sqrt{2}} \qquad ( 21 )$$

where U_{M} exhibits a positive correlation with R_{f}. When the fault resistance is large, the output voltage may exceed its rated value, potentially leading to system over-voltage. Therefore, the voltage constraint of the sending-end converter station should be considered.

For the renewable energy station, the active power outputs of the stations 1 and 2 can be expressed as follows:

$${P}_{w 1}^{*} = Re \{ [ ( {\dot{I}}_{w 1}^{*} - {\dot{I}}_{0}^{*} ) {R}_{f} + {\dot{I}}_{w 1}^{*} ( {R}_{1} + {jX}_{1} ) ] \overline{{\dot{I}}_{w 1}^{*}} \} \qquad ( 22 )$$

$${P}_{w 2}^{*} = Re \{ [ ( {\dot{I}}_{w 1}^{*} - {\dot{I}}_{0}^{*} ) {R}_{f} - {\dot{I}}_{0}^{*} ( {R}_{0} + {jX}_{0} ) + {\dot{I}}_{w 2}^{*} ( {R}_{2} + {jX}_{2} ) ] \overline{{\dot{I}}_{w 2}^{*}} \} \qquad ( 23 )$$

$${\dot{I}}_{0}^{*} = \frac{{R}_{f}}{R + jX} {\dot{I}}_{w 1}^{*} - \frac{{jX}_{t}}{R + jX} {\dot{I}}_{w 2}^{*} - \frac{1}{R + jX} {U}_{M}^{*} \qquad ( 24 )$$

where R₁ and X₁ represent an equivalent resistance and reactance from an outlet of the renewable energy station on the faulted branch to the fault point; and R₂ and X₂ represent an equivalent resistance and reactance from an outlet of the renewable energy station on the non-faulted branch to the PCC.

The optimal active power of the renewable energy station may be less than its actual available active power, necessitating consideration of its active power constraint.

Extending the aforementioned constraints to N wind farms yields the RMS current value of the converter station:

$${I}_{M}^{*} = \frac{{C}_{1} {I}_{w 1 max} + {C}_{2} {\sum }_{i = 2}^{N} {I}_{wi max}}{\sqrt{2}} \qquad ( 25 )$$

$${C}_{1} = \frac{{R}_{f}}{2 R} \qquad ( 26 )$$

$${C}_{2} = \sqrt{\frac{1}{4} + \frac{{x}_{0}^{2}}{4 {R}^{2}}} \qquad ( 27 )$$

where R_{f} represents the fault resistance; I_{wimax} represents the maximum output current of the i^{th} station; and X₀ represents the equivalent reactance from the fault point to the PCC.

Based on the fault information, the output voltage of the sending-end converter station under the theoretical optimal control of the common controlled variables for the renewable energy station and the sending-end converter station is calculated according to the following formula:

$${U}_{M}^{*} = \frac{{R}_{f} \sqrt{{R}^{2} + {X}^{2}} {I}_{w 1 max} + \sqrt{{( {R}^{2} + {XX}_{0} )}^{2} + {( {RX}_{t} )}^{2}} {\sum }_{i = 2}^{N} {I}_{wimax}}{2 \sqrt{2} R} \qquad ( 28 )$$

where R_{f} represents the fault resistance; I_{wimax} represents the maximum output current of the i^{th} station; X₀ represents the equivalent reactance from the fault point to the PCC; and Xₜ represents the leakage inductance of the connected transformer.

Based on the fault information, the active power output of the renewable energy station under the theoretical optimal control of the common controlled variables for the renewable energy station and the sending-end converter station is calculated according to the following formulas:

$${P}_{w 1}^{*} = Re \{ [ ( {\dot{I}}_{w 1}^{*} - {\dot{I}}_{0}^{*} ) {R}_{f} + {\dot{I}}_{w 1}^{*} ( {R}_{1} + {jX}_{1} ) ] \overline{{\dot{I}}_{w 1}^{*}} \} \qquad ( 29 )$$

$${P}_{wi}^{*} = Re \{ [ ( {\dot{I}}_{w 1}^{*} - {\dot{I}}_{0}^{*} ) {R}_{f} - {\dot{I}}_{0}^{*} ( {R}_{0} + {jX}_{0} ) + {\dot{I}}_{wi}^{*} ( {R}_{i} + {jX}_{i} ) ] \overline{{\dot{I}}_{wi}^{*}} \} \qquad ( 30 )$$

$${\dot{I}}_{0}^{*} = \frac{{R}_{f}}{R + jX} {\dot{I}}_{w 1}^{*} - \frac{{jX}_{t}}{R + jX} {\dot{I}}_{w 1}^{*} - \frac{1}{R + jX} {U}_{M}^{*} \qquad ( 31 )$$

where

$${P}_{w 1}^{*} and {P}_{wi}^{*}$$

represent active power outputs of the renewable energy station on the faulted branch and the renewable energy station on the non-faulted branch, respectively; Rᵢ and Xᵢ represent an equivalent resistance and reactance from an outlet of a renewable energy station on an i^{th} non-faulted branch to the PCC; R_{f} represents the fault resistance; and R₀ and X₀ represent an equivalent resistance and the equivalent reactance from the fault point to the PCC.

S1011: determining whether the RMS current value of the sending-end converter station, the output voltage of the sending-end converter station, and the active power output of the renewable energy station exceed their limits: if yes, by taking theoretical optimal values of the common controlled variables for the renewable energy station and the sending-end converter station as initial guess points, solving for reference values of the controlled variables through nonlinear programming, and using the solved reference values of the controlled variables as the control commands; or, if no, using theoretical optimal values of the common controlled variables for the renewable energy station and the sending-end converter station as reference values of the controlled variables, and using the reference values of the controlled variables as the control commands.

Based on the above analysis, the maximum active power transmission problem is transformed into a constrained single-objective nonlinear programming problem, i.e.:

$$max {P}_{M} ( {I}_{wj} , {θ}_{wj} , {U}_{M} ) \qquad ( 32 )$$

$$s . t \{ \begin{matrix}0 \leq {U}_{M} \leq {U}_{Mlim} \\ 0 \leq \vert {I}_{M} ( {I}_{wj} , {θ}_{wj} , {U}_{M} ) \vert \leq {I}_{Mlim} \\ 0 \leq {I}_{wj} \leq {I}_{wjmax} \\ 0 \leq {P}_{wj} ( {I}_{wj} , {θ}_{wj} , {U}_{M} ) \leq {P}_{wilim}\end{matrix} ( j = 1 , 2 , 3 … N )$$

where U_{Mlim} and I_{Mlim} represent AC output voltage and current limits of the sending-end converter station, respectively; and P_{wjlim} represents an output power limit of j^{th} station.

This problem is a small-scale programming problem. By utilizing the initial guess points provided in Expression (17), various algorithms can be employed to rapidly obtain the controlled variables. For the system shown in FIG. 2, a solution approach based on the fmincon function in MATLAB is presented below for reference.

The solution function is defined as follows:

$$[ x , fval ] = fmincon ( fun , x 0 , A , b , Aeq , beq , lb , ub , nonlcon )$$

where
x returns values of the controlled variables, namely I_{w1}, I_{w2}, O_{wl}, θ_{w2}, and U_{M};
fval returns a value of the objective function, namely P_{M};
fun is a nonlinear objective function defined in an M-file, corresponding to Formula (10);
x₀ represents an initial value of x, as defined in Expression (17);
A, b, Aeq, and beq define linear constraints. Since this disclosure does not involve linear constraints, A=[ ], b=[ ], Aeq=[ ], and beq=[ ];
lb and ub are lower and upper bounds of the variable x, respectively: lb=[0; 0; −π; −π; 0], ub=[I_{w1max}; I_{w2max}; π; π; U_{Mlim}]; and
nonlcon defines nonlinear constraints in an M-file, with all the constraints shown in Expression (32).

The iteratively solved x and fval yield the values of the controlled variables and the optimal transmitted active power P_{M}, respectively.

S102: transmitting the control commands to the renewable energy station and the sending-end converter station to achieve fault ride-through control.

In this embodiment, fault equivalent models for the renewable energy station and the sending-end converter stations are proposed, and these models fully leverage the flexible control and coordination capabilities of the two types of converters, helping improve the grid-connected performance of renewable energy VSC-HVDC islanded systems during a fault. Moreover, when AC collection lines at the sending end experience a fault of any severity, the renewable energy station and the sending-end converter station are controlled through the control commands, greatly reducing the active power deficit imposed on the onshore grid due to sending-end faults. This solution fully considers operational constraints of both the renewable energy station and the converter station, ensuring their safe operation during a fault.

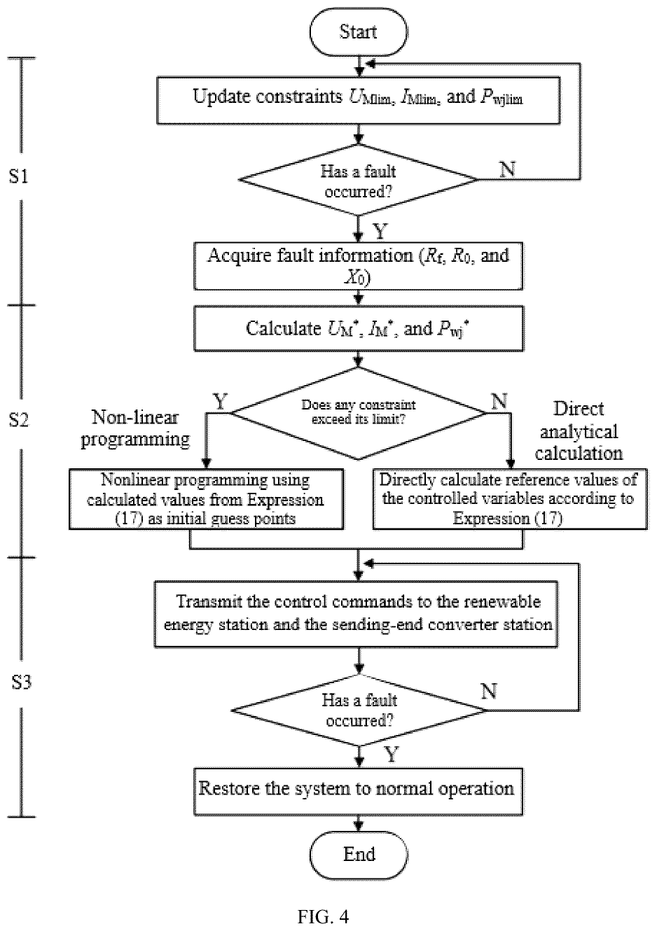

FIG. 4 is a detailed flow chart of a fault ride-through method for a renewable energy integration converter station according to an embodiment of this disclosure. Based on the above embodiments, this embodiment further optimizes and extends the method. The specific steps are as follows:

S1: fault detection and information acquisition: updating constraints U_{Mlim}, I_{Mlim}, and P_{wjlim} in real time for a renewable energy station and a sending-end converter station, and determining whether a fault has occurred: if yes, acquiring fault information including R_{f}, R₀, and X₀; or, if no, continuing to update the constraints U_{Mlim}, I_{Mlim}, and P_{wjiim}.

S2: calculation of control commands for the renewable energy station and the converter station: calculating theoretical values for a current

$${I}_{M}^{*}$$

and voltage

$${U}_{M}^{*}$$

of the sending-end converter station, as well as a theoretical value for an active power output P^{*wj} of the renewable energy station (including stations on faulted and non-faulted branches) under control according to Expression (17) using Formulas (25), (28), (29), and (30), and determining whether the theoretical values exceed their limits: if none of the constraints exceeds its limit, directly using calculated values from Expression (17) as control reference values; or, if any of the constraints exceeds its limit, using calculated values from Expression (17) as initial guess points and solving for reference values of the controlled variables via nonlinear programming.

S3: implementation of fault ride-through control: transmitting the control commands to the renewable energy plants and sending-end converter station, which cooperate to achieve maximum active power transmission during the fault, and determining whether the fault has been cleared: if yes, restoring the system to normal operation; or, if no, continuing transmitting the control commands to the renewable energy station and the sending-end converter station.

It should be understood that the serial number of each step in the above embodiments does not indicate the execution sequence, which should be determined by the function and internal logic of the step, and shall not limit the implementation of the embodiments of this disclosure.

This disclosure possesses the following characteristics and delivers the corresponding beneficial effects:
1: the fault equivalent models for the renewable energy station and the sending-end converter stations proposed fully leverage the flexible control and coordination capabilities of the two types of converters, helping improve the grid-connected performance of renewable energy VSC-HVDC islanded systems during a fault;
2: the maximum active power transmission theory proposed in this disclosure provides the beneficial effect of enabling the renewable energy station to deliver the maximum possible active power to the onshore grid during a fault of any severity occurring in the sending-end AC collection lines, thereby greatly reducing the active power deficit imposed on the onshore grid due to sending-end faults; and
3: the control method considering operational constraints of the renewable energy station and the converter station proposed in this disclosure provides the beneficial effect of ensuring operational safety during a fault by accounting for various operational constraints of the converters.

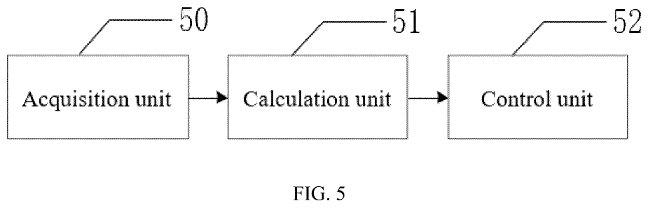

As shown in FIG. 5, the following describes an embodiment of a fault ride-through system for a renewable energy integration converter station provided in this disclosure. This embodiment shares the same inventive concept as the fault ride-through method for the renewable energy integration converter station described in the above embodiments. For details not exhaustively described in this embodiment of the fault ride-through system for the renewable energy integration converter station, reference may be made to the above embodiments of the fault ride-through method for the renewable energy integration converter station.
an acquisition unit 50, configured to perform fault detection on a renewable energy station and a sending-end converter station, and acquire fault information upon detecting a fault;
a calculation unit 51, configured to calculate, based on the fault information, control commands for the renewable energy station and the sending-end converter station; and
a control unit 52, configured to transmit the control commands to the renewable energy station and the sending-end converter station to achieve fault ride-through control.

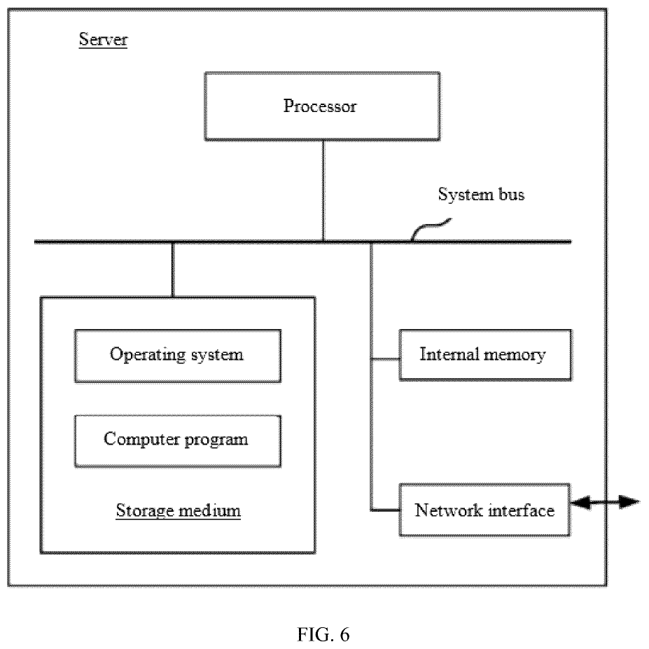

FIG. 6 is a schematic hardware structure diagram of an electronic device according to the embodiments of this disclosure.

The fault ride-through method for the renewable energy integration converter station provided by the embodiments of this disclosure may be implemented in an electronic device. Those skilled in the art will appreciate that the electronic device structure described in the embodiments of this disclosure does not constitute any limitation to the electronic device, and the electronic device may include more or fewer components than those illustrated, or combine certain components, or have different component arrangements. In the embodiments of this disclosure, the electronic device includes, but is not limited to, a laptop computer, a desktop computer, a workbench, a personal digital assistant, a server, a blade server, a mainframe computer, and other suitable computers. The electronic device may also represent various types of mobile devices, such as personal digital assistants, cell phones, smart phones, wearable devices, and other similar computing devices. The components and their connections, relationships, and functions shown herein are presented by way of example only, and are not intended to limit the implementation of the embodiments of this disclosure described and/or required herein.

The electronic device may include a processor, an external memory interface, an internal memory, a universal serial bus (USB) interface, a charging management module, a power management module, a battery, a wireless communication module, an audio module, a speaker, a microphone, a sensor module, keys, a camera, a display screen, and a subscriber identity module (SIM) card interface.

It should be understood that the structure illustrated in the embodiments of this disclosure does not constitute a specific limitation to the electronic device. In other embodiments of this disclosure, the electronic device may include more or fewer components than those illustrated, or combine certain components, or split certain components, or have different component arrangements. The components illustrated may be implemented in hardware, software, or a combination of hardware and software.

The processor may include one or more processing units, such as a central processing unit (CPU), an application processor (AP), a modem processor, a graphics processing unit (GPU), an image signal processor (ISP), a controller, a memory, a video codec, a digital signal processor (DSP), a baseband processor, and/or a neural network processing unit (NPU). Among these, different processing units may be independent devices or integrated into one or more processors.

The processor may serve as the neural center and command hub of the electronic device. The controller may, in accordance with instruction operation codes and timing signals, generate operational control signals to complete the control of instruction fetching and execution.

The processor may further incorporate a memory for storing instructions and data. In some embodiments, the memory within the processor is a cache memory, which may retain instructions or data that the processor has recently used or frequently accesses in cycles. When the processor requires these instructions or data again, it can retrieve them directly from this memory, thereby eliminating redundant fetch operations, reducing processor wait time, and consequently enhancing system efficiency.

The external memory interface may be configured to connect external storage cards, such as Micro SD cards, to expand the storage capacity of the electronic device. The external storage card communicates with the processor through the external memory interface to implement data storage functions, such as saving music, video, and other files on the external storage card.

The internal memory may be configured to store computer-executable program code, which includes instructions. The processor executes various functional applications and performs data processing for the electronic device by running the instructions stored in the internal memory. The internal memory may include a program storage area and a data storage area. Additionally, the internal memory may include a high-speed random access memory and may further include a non-volatile memory, such as at least one disk storage device, flash memory device, or universal flash storage (UFS).

The wireless communication functionality of the electronic device may be implemented through antennas, wireless communication modules, modem processors, or baseband processors.

The wireless communication module may provide various wireless communication solutions for the electronic device, including a wireless local area network (WLAN) (e.g., a wireless fidelity (Wi-Fi) network), Bluetooth (BT), a global navigation satellite system (GNSS), frequency modulation (FM), near field communication (NFC), and infrared (IR) technology.

The electronic device may implement audio functionality through an audio module, a speaker, a receiver, a microphone, a headphone interface, or an application processor.

The electronic device may implement photography functionality through an ISP, a camera, a video codec, a GPU, a display screen, or an application processor.

The electronic device may implement display functionality through a GPU, a display screen, or an application processor.

The GPU serves as a microprocessor dedicated to image processing, connecting both the display screen and the application processor. The GPU is configured to execute mathematical and geometric computations and perform graphics rendering operations. The processor may include one or more GPUs that execute program instructions to generate or modify display information.

The display screen is configured to display visual content such as images and videos. The display screen includes a display panel.

The storage medium provided in this disclosure stores a program product capable of implementing the fault ride-through method for the renewable energy integration converter station.

The fault ride-through method for the renewable energy integration converter station includes: performing fault detection on a renewable energy station and a sending-end converter station, and acquiring fault information upon detecting a fault; calculating, based on the fault information, control commands for the renewable energy station and the sending-end converter station; and transmitting the control commands to the renewable energy station and the sending-end converter station to achieve fault ride-through control.

In some possible implementation manners, the subject matter of this disclosure, namely the fault ride-through method and system for the renewable energy integration converter station may be embodied as a program product including program code that, when the program product is executed on a terminal device, causes the terminal device to perform the steps according to various exemplary implementation manners of this disclosure as described in the aforementioned exemplary embodiments of the specification.

The storage medium of this disclosure may employ any combination of one or more readable storage media. The readable storage medium may be either a readable signal medium or a readable storage medium, where the readable storage medium may be, but is not limited to, an electrical, magnetic, optical, electromagnetic, infrared, or semiconductor system, apparatus, or device, or any combination thereof. More specific examples (a non-exhaustive list) of the readable storage medium include: an electrical connection having one or more wires, a portable disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

The above description of the disclosed embodiments enables those skilled in the art to implement or use this disclosure. Various modifications to these embodiments will be readily apparent to those skilled in the art, and the generic principles defined herein may be implemented in other embodiments without departing from the spirit or scope of this disclosure. Therefore, this disclosure is not intended to be limited to the embodiments shown herein, but is to be in accordance with the widest scope consistent with the principles and novel features disclosed herein.

What is claimed is:

1. A fault ride-through method for a renewable energy integration converter station, comprising:
performing fault detection on a renewable energy station and a sending-end converter station, and acquiring fault information upon detecting a fault;
calculating, based on the fault information, an RMS current value of the sending-end converter station, an output voltage of the sending-end converter station, and an active power output of the renewable energy station under theoretical optimal control of common controlled variables for the renewable energy station and the sending-end converter station;
determining whether the RMS current value of the sending-end converter station, the output voltage of the sending-end converter station, and the active power output of the renewable energy station exceed their limits: if yes, by taking theoretical optimal values of the common controlled variables for the renewable energy station and the sending-end converter station as initial guess points, solving for reference values of the controlled variables through nonlinear programming, and using the solved reference values of the controlled variables as control commands; or, if no, using theoretical optimal values of the common controlled variables for the renewable energy station and the sending-end converter station as reference values of the controlled variables, and using the reference values of the controlled variables as control commands, wherein the theoretical optimal values of the common controlled variables for the renewable energy station and the sending-end converter station are represented as follows:
$$\{ \begin{matrix}{I}_{w 1}^{*} = \frac{{I}_{w 1 max}}{\sqrt{2}} \\ {I}_{wi}^{*} = \frac{{I}_{wi max}}{\sqrt{2}} \\ {θ}_{w 1}^{*} = \frac{π}{2} - arc tan ( \frac{R}{X} ) \\ {θ}_{wi}^{*} = \frac{π}{2} - arc tan ( \frac{{R}^{2} + {XX}_{0}}{{RX}_{t}} ) \\ {U}_{M}^{*} = \frac{{R}_{f} \sqrt{{R}^{2} + {X}^{2}} {I}_{w 1 max}}{2 \sqrt{2} R} + \\ \frac{\sqrt{{( {R}^{2} + {XX}_{0} )}^{2} + {( {RX}_{t} )}^{2}} {\sum }_{i = 2}^{N} {I}_{wimax}}{2 \sqrt{2} R}\end{matrix} i = 2 , 3 , 4 … N$$
wherein w1 represents a renewable energy station on a faulted branch; wi represents a renewable energy station on a non-faulted branch; I_{wimax} represents a maximum output current of an i^{th} station; R_{f} represents a fault resistance; Xₜ represents leakage inductance of a connected transformer; X₀ represents an equivalent reactance from a fault point to a point of common coupling; R=R_{f}+R₀, representing a total fault resistance; R0 represents an equivalent resistance from the fault point to the point of common coupling; X=Xₜ+X₀; * represents a theoretical optimal value without considering other constraints; U_{M} represents the output voltage of the sending-end converter station; and θ_{wi} represents a phase angle of an output current of the renewable energy station; and
transmitting the control commands to the renewable energy station and the sending-end converter station to achieve fault ride-through control.

2. The fault ride-through method for the renewable energy integration converter station of claim 1, wherein before the step of performing the fault detection on the renewable energy station and the sending-end converter station, and acquiring the fault information upon detecting the fault, the fault ride-through method for the renewable energy integration converter station further comprises: establishing fault equivalent models for the renewable energy station and the sending-end converter station:
equivalently modeling the renewable energy station and the sending-end converter station as a controlled current source and a controlled voltage source, respectively, wherein a root-mean-square value and phase angle of the output current of the controlled current source are controlled variables; and a root-mean-square value of the output voltage of the controlled voltage source is a controlled variable.

3. The fault ride-through method for the renewable energy integration converter station of claim 1, wherein based on the fault information, the root-mean-square current value of the sending-end converter station under the theoretical optimal control of the common controlled variables for the renewable energy station and the sending-end converter station is calculated according to the following formulas:
$${I}_{M}^{*} = \frac{{C}_{1} {I}_{w 1 max} + {C}_{2} {\sum }_{i = 2}^{N} {I}_{wi max .}}{\sqrt{2}} ;$$
$${C}_{1} = \frac{{R}_{f}}{2 R} ;$$
$${C}_{2} = \sqrt{\frac{1}{4} + \frac{{x}_{0}^{2}}{4 {R}^{2}}} ;$$
wherein R_{f} represents the fault resistance; I_{wimax} represents the maximum output current of the i^{th} station; and X₀ represents the equivalent reactance from the fault point to the PCC.

4. The fault ride-through method for the renewable energy integration converter station of claim 1, wherein based on the fault information, the output voltage of the sending-end converter station under the theoretical optimal control of the common controlled variables for the renewable energy station and the sending-end converter station is calculated according to the following formula:
$${U}_{M}^{*} = \frac{{R}_{f} \sqrt{{R}^{2} + {X}^{2}} {I}_{w 1 max} + \sqrt{{( {R}^{2} + {XX}_{0} )}^{2} + {( {RX}_{t} )}^{2}} {\sum }_{i = 2}^{N} {I}_{wimax .}}{2 \sqrt{2} R} ;$$
wherein R_{f} represents the fault resistance; I_{wimax} represents the maximum output current of the i^{th} station; X₀ represents the equivalent reactance from the fault point to the PCC; and Xₜ represents the leakage inductance of the connected transformer.

5. The fault ride-through method for the renewable energy integration converter station of claim 1, wherein based on the fault information, the active power output of the renewable energy station under the theoretical optimal control of the common controlled variables for the renewable energy station and the sending-end converter station is calculated according to the following formulas:
$${P}_{w 1}^{*} = Re \{ [ ( {\dot{I}}_{w 1}^{*} - {\dot{I}}_{0}^{*} ) {R}_{f} + {\dot{I}}_{w 1}^{*} ( {R}_{1} + {jX}_{1} ) ] \overline{{\dot{I}}_{w 1}^{*}} \} ;$$
$${P}_{wi}^{*} = Re \{ [ ( {\dot{I}}_{w 1}^{*} - {\dot{I}}_{0}^{*} ) {R}_{f} - {\dot{I}}_{0}^{*} ( {R}_{0} + {jX}_{0} ) + {\dot{I}}_{wi}^{*} ( {R}_{2} + {jX}_{i} ) ] \overline{{\dot{I}}_{wi}^{*}} \} ;$$
wherein
$${P}_{w 1}^{*} and {P}_{wi}^{*}$$
represent active power outputs of the renewable energy station on the faulted branch and the renewable energy station on the non-faulted branch, respectively; Rᵢ and X₁ represent an equivalent resistance and reactance from an outlet of a renewable energy station on an i^{th} non-faulted branch to the PCC; R_{f} represents the fault resistance; and R₀ and X₀ represent the equivalent resistance and the equivalent reactance from the fault point to the PCC.

6. A fault ride-through system for a renewable energy integration converter station, wherein the system is configured to implement the fault ride-through method for the renewable energy integration converter station of claim 1 and comprises:
an acquisition unit, configured to perform fault detection on a renewable energy station and a sending-end converter station, and acquire fault information upon detecting a fault;
a calculation unit, configured to calculate, based on the fault information, control commands for the renewable energy station and the sending-end converter station; and
a control unit, configured to transmit the control commands to the renewable energy station and the sending-end converter station to achieve fault ride-through control.

7. An electronic device, comprising a memory, a processor, and a computer program stored on the memory and executable on the processor, wherein the processor, when executing the computer program, implements the steps of the fault ride-through method for the renewable energy integration converter station of claim 1.

8. A non-transitory storage medium with a computer program stored thereon, wherein the computer program, when executed by a processor, implements the steps of the fault ride-through method for the renewable energy integration converter station of claim 1.
